(19) United States
(12) Patent Application Publication
(10) Pub. No.: US 2025/0312230 A1
(43) Pub. Date: Oct. 9, 2025

(54) Wearable articles for myofascial tissue therapy

(71) Applicant: PT CLOTHING, INC, New Prague, MN (US)

(72) Inventors: Michael O'Rourke, New Prague, MN (US); Paul Berg, New Prague, MN (US)

(21) Appl. No.: 18/864,807

(22) PCT Filed: May 12, 2023
(86) PCT No.: PCT/US2023/021990

§ 371 Date: Nov. 11, 2024

Related U.S. Application Data
(60) Provisional application No. 63/341,060, filed on May 12, 2022.

(51) Int. Cl. A61H 7/00

(52) U.S. Cl. CPC A61H 7/001; A61H 7/003; A61H 2201/02; A61H 2201/10; A61H 2201/1253; A61H 2201/1611; A61H 2201/1621; A61H 2201/1626; A61H 2201/1638; A61H 2201/1642; A61H 2201/165

(57) ABSTRACT

Articles (10) that are wearable for muscle therapy are provided. The articles (10) are compression garments and/or have compression sections (12) that can house a trigger object (14). The trigger object (14) rests on a trigger point between the compression section (12) and the individual's targeted muscle. When an individual wears the article (10), the trigger object (14) acts upon the trigger point and provides myofascial tissue release in the targeted area. The trigger objects (14) can be varied with respect to material, consistency, size, temperature and vibration. Methods for using the articles are also provided.

This disclosure relates to articles for physical therapy and more particularly to articles that provide therapy to myofascial tissue.

### BACKGROUND

Myofascial tissue is a type of thin, strong, fibrous connective tissue that extends throughout the body to provide support and protection to muscles and bones. Myofascial release therapy is a medical therapy used in the treatment of skeletal muscle immobility, the aim of which is to reduce pain by relaxing contracted muscles, improving blood flow and lymphatic circulation to those muscles, and stimulating the stretch reflex of the affected muscles. Such therapy has classically involved manual manipulation or, more recently, device-assisted compression of the affected muscle groups to promote the intended treatment. Such compression may be effected via general compression force, for broad treatment of larger muscle groups, or may be effected via trigger point compression, for more focused treatment of specifically identified pathological sites.

### SUMMARY

In one aspect, the present description relates to a wearable article. The wearable article includes at least one compression section and a trigger object, wherein the compression section and the trigger object are configured to rest at a trigger point in an individual and encourage myofascial tissue release when the article is worn by the individual. The trigger object can be housed in the compression section of the article. Multiple trigger objects can be spaced apart and housed in the same compression section. The trigger object may be a cylinder, a sphere, a circle, an oval, a square, a cube, a rectangle, a hexagon, a pentagon, a triangle, an arc, a crescent, an octagon, a wedge, a pie, a trapezoid, shapes with spikes, shapes with ribs, shapes with dimples, shapes with texture or combinations thereof. The trigger object materials may include foam, metal, gel, plastic, wood, polymer, stone, rubber, cork, natural materials, corn, rice, hemp, cannabidiol (CBD) or combinations thereof. The largest dimension of the trigger object may be between about 1 millimeter mm and about 100 mm. The temperature of the trigger object may be modulated. The consistency of the trigger object may be modulated. The size and shape of the trigger object may be configured to deliver myofascial tissue release to the individual. The article may include a shirt, an arm sleeve, an elbow sleeve, a sleeve, a long sleeve shirt, shorts, lower leg sleeves, full length pants, back wraps, neck wraps, braces, socks, gloves or combinations thereof. The article may include housing on the inner surface of the article, wherein the housing retains the trigger object between the compression section and the trigger point in the individual. The article may further include a mechanical, electrical and/or a programmable stimulation device.

In another aspect, the present description includes a method of delivering muscle therapy to an individual. The method includes wearing a wearable article including a compression section and a trigger object. The compression section and the trigger object are configured to rest at a trigger point when worn by an individual. The trigger object is housed in the compression section of the article. The method can further include manipulating the trigger object to release myofascial tissue at a trigger point in the individual. The wearable article may include a shirt, an arm sleeve, an elbow sleeve, a sleeve, a long sleeve shirt, shorts, lower leg sleeves, full length pants, back wraps, neck wraps, braces, socks or combinations thereof. The manipulating may include modulating the pressure applied at the trigger point by the trigger object. The manipulating may include adjusting the size of the trigger object for adaptability to the size of the trigger point in the myofascial release area. The manipulating may include varying the temperature of the trigger object applied to the trigger point. The trigger object material may include foam, metal, gel, plastic, wood, polymer, stone, rubber, cork, natural materials, corn, rice, hemp, CBD or combinations thereof. The article may be worn for a length of time between about 10 minutes and about 60 minutes. The manipulating may include moving the trigger object over the body part to release the myofascial tissue. The manipulating may include moving the body part to release the myofascial tissue. The article may be worn for muscle recovery after an athletic event, for muscle preparation before an athletic event, for improving the effectiveness of athletic training, for post-surgical recovery, for rehabilitation and/or for pain relief.

In a further aspect, the present description relates to a method of delivering muscle therapy to an individual. The method includes manipulating a trigger object housed in a compression section of a wearable article. The compression section and the trigger object are configured to rest at a trigger point when worn by an individual. The manipulating includes release of myofascial tissue at a trigger point in the individual by the trigger object. The manipulating may include modulating the pressure applied at the trigger point by the trigger object. The manipulating may include adjusting the size of the trigger object for adaptability to the size of the trigger point in the myofascial release area. The manipulating may include varying the temperature of the trigger object applied to the trigger point. The trigger object material may include foam, metal, gel, plastic, wood, polymer, stone, rubber, cork, natural materials, corn, rice, hemp, CBD or combinations thereof. The article may be worn for a length of time between about 10 minutes and about 60 minutes. The manipulating may include moving the trigger object over the body part to release the myofascial tissue. The manipulating may include moving the body part to release the myofascial tissue. The article may be worn for muscle recovery after an athletic event, for muscle preparation before an athletic event, for improving the effectiveness of athletic training, for post-surgical recovery, for rehabilitation and/or for pain relief.

In yet another aspect, A wearable article comprises one or more compression sections; one or more trigger objects secured within one or more housings; wherein the one or more housings are secured inside the wearable article at the one or more compression sections, wherein the one or more compression sections are spaced apart on the wearable article; wherein the one or more trigger objects are spherical and comprise a foam material; and wherein the one or more housings have dimensions greater than the one or more trigger objects allowing for manual positioning of the trigger objects within the housing when the wearable object is worn by an individual. The wearable article is a shirt, an arm sleeve, an elbow sleeve, a sleeve, a long sleeve shirt, shorts, lower leg sleeves, full length pants, back wraps, neck wraps, braces, socks, or gloves. The wearable article is constructed from a compressive material or a fabric comprising an elastic component. At least one of the one or more compression sections is provided to surround the individual when worn and wherein the at least one of the one or more compression sections comprise a plurality of housings with a trigger object therein wherein the plurality of housings are provided spaced apart across a surface area of the at least one of the one or more compression sections such that the trigger objects are positioned on two or more spaced apart locations of the at least one compression section. The two or more locations are provided on a front, a rear, a right side, a left side or combinations thereof of the at least one of the one or more compression sections.

### BRIEF DESCRIPTION OF THE DRAWINGS

FIG. 1A is a front view of an exterior of one embodiment of a wearable article according to one or more embodiments described herein.

FIG. 1B is a rear view of the exterior of one embodiment of the wearable article.

FIG. 1C is a side view of the exterior of one embodiment of the wearable article.

FIG. 2A is a front view of an interior of one embodiment of the wearable article.

FIG. 2B is a front view of an interior of one embodiment of the wearable article.

FIG. 3A is a front view of a compression section.

FIG. 3B is a front view of another compression section.

FIG. 4A is a rear view of the compression section of FIG. 3A.

FIG. 4B is a rear view of the compression section of FIG. 3B.

FIG. 5 illustrates a method of forming a compression section.

FIGS. 6A and 6B illustrate front and rear views of another embodiment of the wearable article.

FIGS. 7A and 7B illustrate front and rear views of another embodiment of the wearable article.

### DETAILED DESCRIPTION

The present description includes wearable articles directed to providing myofascial tissue release in an individual. The wearable articles can include one or more compression sections and one or more trigger objects. Each compression section and the one or more trigger objects are configured to rest at one or more trigger points in an individual to encourage myofascial release when the article is worn by an individual. One or more articles, each article with one or more compression sections can be worn concurrently such that one or more areas on the individual can be subjected to myofascial tissue release concurrently.

One or more trigger objects are housed within the article in a compression section and each trigger object may be positioned to rest between the compression section and a trigger point of the individual.

The present disclosure also includes methods of providing myofascial release with one or more wearable articles having one or more compression sections and one or more trigger objects. The method includes placing the one or more trigger objects over a trigger point to encourage myofascial release at the trigger point in the individual.

The use of the product is advantageous for improved muscle recovery and/or full muscle recovery after an athletic event or a medical event. The article can also better prepare the muscles prior to training or prior to an athletic event.

In one or more embodiments, the wearable article is a product designed to help with muscle recovery after an athletic event and/or is designed for muscle preparation prior to an athletic event or prior to rehab. The articles may include at least one compression section. By “compression section,” it is meant that the article, fully or partially, is sized and constructed with a material or materials in a manner that applies pressure to the individual's myofascial tissue when the article is in use by the individual. Compression sections may include one or more compression agents. Compression agents may be, for example, stitching, compression material, pockets, objects, straps and the like and combinations thereof.

In one or more embodiments, the article is provided with at least one portion of the article including a compression section.

In one or more embodiments, the article can be configured to provide compression throughout the surface of the individual covered by the article.

In one or more embodiments, the compression section of the article can include one or more trigger objects attached to or supported therein or thereon. The trigger objects may be incorporated into the article in a variety of ways. In some embodiments, the trigger objects may be incorporated in a removable manner. The article, for example, may include housings such as pouches, pockets, sleeves or the like for receiving and holding the trigger object(s) in place at the desired article location corresponding to the wearer's trigger point. The housings may enclose all or part of the trigger object. The trigger object may be placed in the housing prior to an individual wearing the article. Alternatively, the trigger object may be placed in the housing after the individual has donned the article. The trigger object may be incorporated permanently in the article. Furthermore, the trigger object(s) may be able to move within the housing such that the precise location of the trigger object against the individual can be adjusted.

In one embodiment, when worn, the trigger object in the article may rest over one or more trigger points in the individual. The article may include more than one trigger object and each of the trigger objects may rest over a different trigger point when worn.

The trigger objects may include a variety of materials and sizes. A variety of article embodiments may be designed based on the different materials and sizes of the trigger objects. In some embodiments, different materials can include, for example, foam, metal, gel, plastic, wood, polymer, stone, rubber, cork, and combinations thereof. In some embodiments, trigger object can include, for example, natural materials such as corn, rice, hemp, cannabidiol (CBD) and the like. In some embodiments, the consistency of the materials forming the trigger object may be varied. Harder foam can be used, for example, if a higher pressure is desired and a less dense or softer foam can be used if less pressure is desired. In one or more embodiments, the consistency of the trigger object can be determined based on the needs of the individual. Additional means for adjusting the pressure provided by the trigger objects when worn relate to selecting a wearable article constructed from and/or comprising one or more compression sections constructed of a medium or high compression fabric and/or increasing the hardness of the trigger object.

A variety of sizes of the trigger object can be used. In some embodiments, the size of the trigger object can be varied depending on the desired use. The size of the trigger object can be substantially the size of a tennis ball, a golf ball, a soft ball, a baseball or the like. Although the size of the trigger objects are described as a spherical or otherwise having a rounded exterior surface, it will be understood that the shape of the object is not limited to a sphere and that other shapes, e.g. cube, in a variety of sizes and consistencies may also be used and all are within the scope of this description. Shapes can include, for example, cylinder, a sphere, a circle, an oval, a square, a cube, a rectangle, a hexagon, a pentagon, a triangle, an arc, a crescent, an octagon, a wedge, a pie, a trapezoid, shapes with spikes, shapes with ribs, shapes with dimples, shapes with texture or combinations thereof. In some embodiments, smaller trigger objects can be used to target a smaller area that can lead to pinpointing the target muscle zone.

The largest dimension of the trigger objects may vary. In some embodiments, the largest dimension of the trigger objects can be greater that about 1 mm, or greater than 1 cm, or greater than about two 100 cm. In some embodiments, the largest dimension of the trigger objects can be between about 1 mm and about 100 cm. Trigger objects with the largest dimension outside of this range are also within the scope of this description.

In some embodiments, the temperature of the trigger objects can be modulated. In some embodiments, the temperature of the trigger object is increased to be higher than the individual's physiological temperature, e.g. about 98° F. In some embodiments, the temperature of the trigger object can be decreased to be cooler than the individual's physiological temperature. The trigger objects may be warmed and/or cooled to a desired temperature. The desired temperature of the trigger object can vary depending on the desired therapy. In one embodiment, a heated trigger object may be included in the article to warm the muscle prior to initiation of activity. In one embodiment, a cold trigger object may be included in the article to cool the muscle after the activity has been completed. A heated and/or a cold trigger object can be used in a number of settings and all are within the scope of this description.

The trigger objects, for example, can be heated prior to the individual donning the article. In some embodiments, the trigger object can be heated while the individual is wearing the article. In some embodiments, the trigger object can be heated to a desired temperature prior to donning the article and maintained at the desired temperature while the individual is wearing the article. A trigger object can be heated to a variety of temperatures and all are within the scope of this description. In some embodiments, the trigger object may be heated to a temperature of greater than about 98° F., or greater than about 125° F., or greater than about 160° F.

The trigger objects, for example, can be cooled prior to the individual donning the article. In some embodiments, the trigger object can be cooled while the individual is wearing the article. In some embodiments, the trigger object can be cooled to a desired temperature prior to donning the article and maintained at the desired temperature while the individual is wearing the article. A trigger object can be cooled to a variety of temperatures and all are within the scope of this description. In some embodiments, the trigger object may be cooled to a temperature of less than about 32° F., or less than about 10° F.

The trigger objects that can retain heat and/or cold can include a variety of materials. In some embodiments, the trigger objects that may be heated and/or cooled can include materials can, for example, metals, gels, liquids, particles, plastic, polymers and combinations thereof. In some embodiments, the trigger objects that may be heated and/or cooled can also include materials, for example, the like or natural materials like corn or rice.

In one embodiment, the trigger object can be a ball/sphere that can be filled with a gel. The gel in the ball can be cooled or heated. In one embodiment, the trigger object can be a metal ball that can be cooled or heated. The heated or cooled trigger object can be applied to heat or cool specific areas of the target muscle. This can lead to a different therapeutic response in the target tissue. In one embodiment, the trigger object can include metal that may be heated or cooled to modulate the temperature. In one embodiment the trigger object can be uncooked rice, dried corn kernels and the like that are packaged in a pouch or other housing that can be warmed or cooled.

In some embodiments, the trigger object may be a vibrating trigger object. The vibration may be generated, for example, electrically, mechanically, by a battery operated mechanism and combinations thereof. The vibrating trigger object may be directed to a targeted area in the individual. Vibration of trigger object when resting on the desired muscle can increase myofascial tissue release and encourage healing in the targeted tissue.

The article may be wearable and may be worn or placed on the individual when a treatment is desired. The article may be a garment that can take a variety of forms and all are within the scope of this description. The article can be a compression garment. By compression garment, it is meant that all and/or part of the article can provide compression pressure to a muscle or muscles of an individual when the article donned on the individual. In some embodiments, the article is a compression garment that is a shirt, a sleeve, e.g. arm sleeve, elbow sleeve, lower leg sleeve, a long sleeve shirt, a pair of shorts (over the pelvic and/or thigh region), a pair of full length pants, wraps, e.g. back wraps and neck wraps, braces, socks and the like. In some embodiments, an individual wearing the article can feel pressure over the muscle and this can encourage the recovery of the individual's muscles.

In some embodiments, the article may include wiring and/or cable to connect to an electrical power source, a battery operated power source, a solar power source or other power sources. In some embodiments, the article may include a programmable device. The article may be connected to the power source and/or the programmable device by a wired connection or a wireless connection. In some embodiment, the article may include an electronic stimulator.

In some embodiments, the present description includes methods of delivering physical therapy to an individual. The method can include providing or wearing a wearable article as described herein. The method can include manipulating the trigger object to release myofascial tissue release. In some embodiments, the manipulation can include moving the body part. Movement of the body part can result in the trigger object exerting pressure and releasing the myofascia. In some embodiments, the trigger object can be moved across a body part resulting in exerting pressure and releasing the myofascia. The manipulation can release the myofascial tissue at a trigger point due to the pressure exerted on the trigger point by the trigger object between the compression section and the individual. In some embodiments, the trigger object can be placed between a compression section and the targeted muscle for therapy. The compression section can hold the trigger object in place at the targeted area. The compression section can also enable the trigger object to exert pressure on the targeted muscle.

In some embodiments, the method may include an individual wearing or donning the article prior to and/or after a workout. In some embodiments, the method may include an individual wearing or donning the article prior to and/or after rehabilitation therapy. In some embodiments, the method may include an individual wearing or donning the article prior to and/or after an athletic event. In some embodiments, the method may include an individual wearing or donning the article prior to and/or after surgery.

An individual may wear the article for variable lengths of time. In some embodiments, the article may be worn by an individual for at least about 5 minutes, or at least about 10 minutes, or at least about 20 minutes, or at least about 30 minutes, or at least about 45 minutes, or at least about 60 minutes, or at least about 90 minutes. The article may be worn for a time period outside of this length and all are within the scope of this description.

In some embodiments, the articles can place specific pressure on the targeted muscle(s) and encourage muscle healing in problem areas. Placing the pressure over the area of muscle tightness and the myofascial tissue in a more specified fashion can encourage muscle release allowing the muscle and surrounding tissue to work at their full potential. In other words, the articles described herein can lead to myofascial release.

In some embodiments, the articles can be used by individuals, e.g. athletes, prior to a competitive event. The use of the article can result in a more effective competition by decreasing muscle dysfunction. In some embodiments, the articles can be used to decrease injuries to the muscle and to the joints they support and the ligaments that support the joint. In some embodiments, the articles can be used to prior to practice to improve performance.

In some embodiments, the articles can be used after competition or practice to allow the muscles to recover more effectively and therefore, improve recovery.

In some embodiments, the articles can be used by individuals that workout for fitness and use of this product can improve recovery and improve the effectiveness of the training.

In some embodiments, the articles can be used post-surgically to improve patient recovery. In some embodiments, the articles can be used for rehabilitation from musculoskeletal injuries.

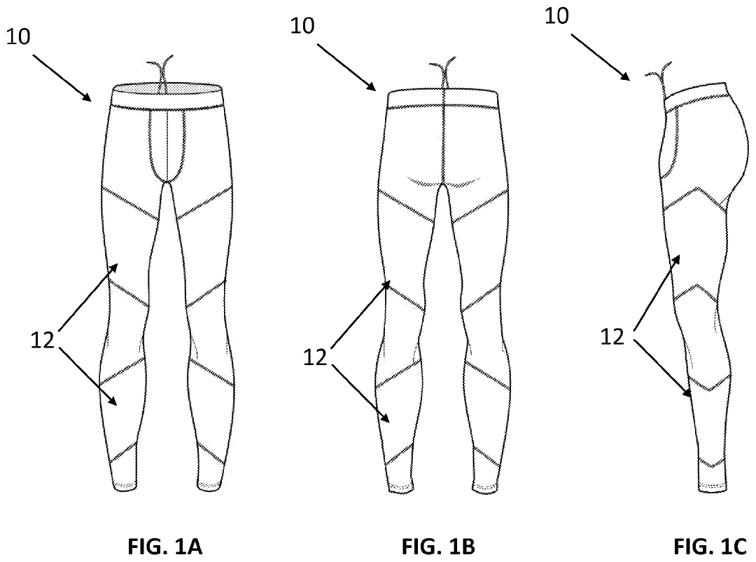

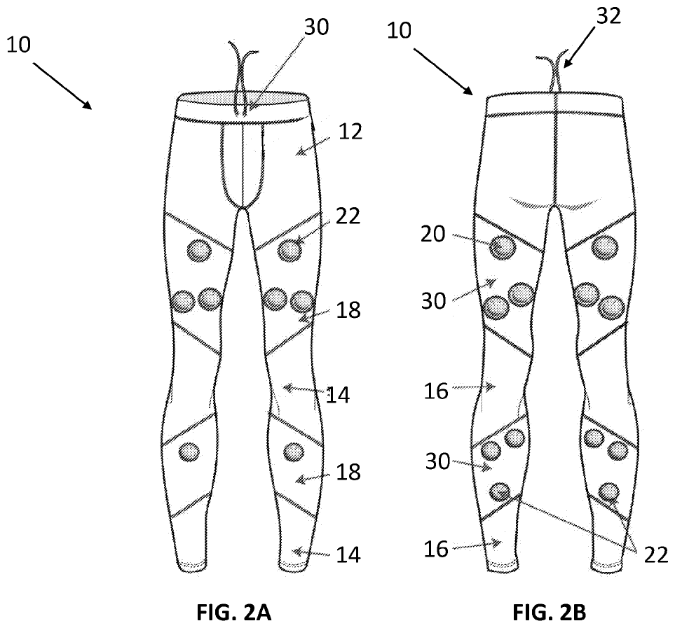

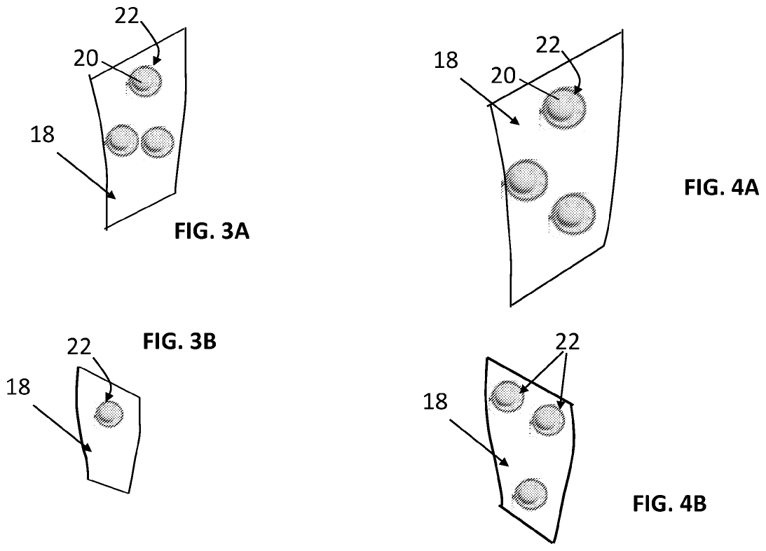

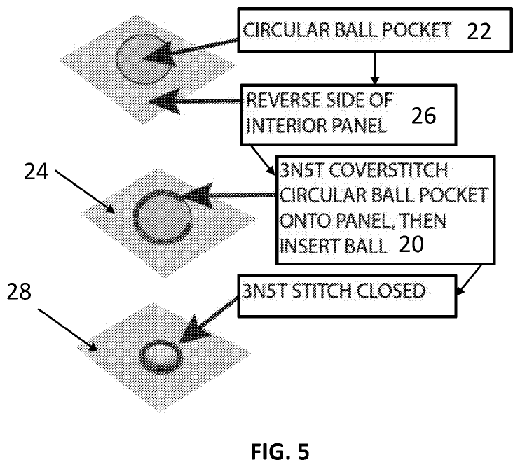

In one embodiment as illustrated in FIGS. 1A-5, the wearable article 10 is a lower body garment, such as pants 12. The wearable article 10 may generally comprise a garment layer 14 which may be single or double layer material having stretch and resilience and/or otherwise having a degree of compressive force on its own. As such, the wearable article 10 may be provided in various sizes such as small, medium and large tailored for a tight fit on the individual and with an interior surface 16 of the wearable article 10 in contact with the skin of the individual. The lower body garment 12 may also be adjustable with an elastic waistband 30 and/or drawstring closure 32. The wearable article 10 comprises a plurality of compression sections 18 spaced apart on the wearable article 10 and positioned for contact with selected areas on the individual. The compression sections 18 each support one or more trigger objects 20.

In the embodiment illustrated the trigger objects 20 are foam balls. The trigger object 20 may have the same dimensions and density or different dimensions or densities as used in one or more compression sections 18 on the same wearable article 10. That is, the pressure provided by the trigger objects 20 may vary as desired for different locations on the individual.

The trigger objects 20 are secured in a housing 22, which in the example illustrated is a pocket 22. The pocket(s) 22 is/are positioned on or in the compression section 18. In some locations, the pocket(s) 22 may support one trigger object 20 and in some locations the pocket 22 may support a plurality of trigger objects 20. The objects 20 are secured in pocket(s) 22 to ensure that the trigger object 20 remains positioned on, at or near the desired location on the individual. The pocket 22 may allow for some movement of the trigger object 20 therein, for example, allowing for manual manipulation of the location of the trigger object 20 by the individual when wearing the article 10.

Each pocket 22 may comprise a pocket panel 24 of material that may be the same or different than the material of the wearable article 10. The pocket 22 is then secured to an interior layer of the wearable article 10 at the compression section 18 with the trigger object 20 positioned between the interior layer of the wearable article 10 and the pocket panel 24 of the pocket 22. An additional panel 26 may be used and secured to the pocket panel 24 with the trigger object 20 secured between the pocket panel 24 and additional panel 26 forming a trigger object assembly 28. The assembly 28 may then be secured to the wearable article 10 at a location on the compression section 18. Multiple assemblies 28 may then be formed and secured to the wearable article at a location on the same or additional compression sections 18. The housings 22 may be formed by way of sewing, heat bonding or other means for securing the panels 24 and 26 together as well as for securing the housing 22 to the inside of the wearable article 10. The housings 22 as shown in the illustrated embodiments are permanently affixed to the inside of the wearable article 10. However, the housings 22 may be removably secured and may also be secured to the outside of the article 10.

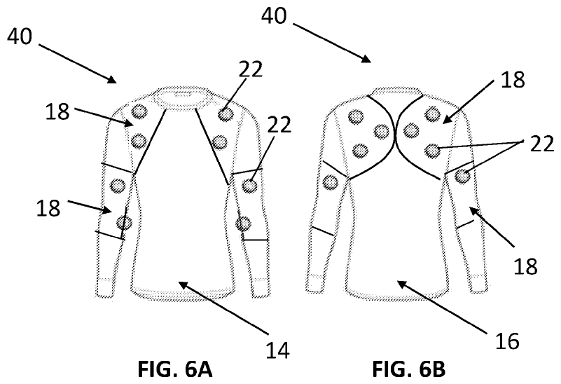

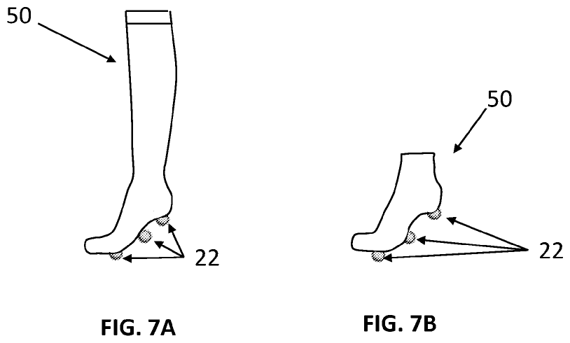

In the wearable article 10 illustrated in FIGS. 1A-4B, the compressions sections 18 surround the individual's limb. That is, the trigger objects 20 can be positioned on a rear and front of the individual as well as the side of the individual. The trigger objects 20 and/or compression sections 18 may be provided spaced apart around the user's calf or thigh for example, as well as arms, chest, and/or back as shown by article 40 in FIGS. 6A-6B and feet as shown by article 50 in FIGS. 7A-7B. This allows the wearable garment 10 to provide focused pressure at multiple locations on the individual at the same time. This also allows for cooperative pressure at these locations concurrently where the pressure can be maintained by wearing the wearable article 10.

The pockets 22 may have dimensions greater than the dimensions of the trigger object 14 in order to allow the placement of the trigger object 20 to be adjusted manually.

In the embodiment illustrated in the figures, the compression sections 18 are multi-ply comprising at least two layers of material wherein the sections or portions of the garment between and/or spacing the compression sections 18 apart may be single ply or a single layer of the same or different material.

The article 10 may be constructed from nylon, spandex, polyester, cotton and blends thereof. The material may be a known compression fabric or an improved version thereof.

In one embodiment as illustrated in FIGS. 6A-6B, the wearable article 10 is an upper body garment, such as a compression shirt 40.

In one embodiment as illustrated in FIGS. 7A-7B, the wearable article 10 is a foot garment, such as compressive socks 50.

Although the present invention has been described with reference to preferred embodiments, workers skilled in the art will recognize that changes may be made in form and detail without departing from the spirit and scope of the invention.

What is claimed is:

1. A wearable article comprising a compression section and a trigger object in the at least one compression section, wherein the compression section and the trigger object are configured to rest at a trigger point in an individual and encourage myofascial tissue release when the article is worn by the individual, wherein the trigger object is housed in the compression section of the article.

2. The article of claim 1, wherein the trigger object is a cylinder, a sphere, a circle, an oval, a square, a cube, a rectangle, a hexagon, a pentagon, a triangle, an arc, a crescent, an octagon, a wedge, a pie, a trapezoid, shapes with spikes, shapes with ribs, shapes with dimples, shapes with texture or combinations thereof.

3. The article of claim 1, wherein the trigger object materials comprise foam, metal, gel, plastic, wood, polymer, stone, rubber, cork, natural materials, corn, rice, hemp, cannabidiol (CBD) or combinations thereof.

4. The article of claim 1, wherein the largest dimension of the trigger object is between about 1 millimeter (mm) and about 100 mm.

5. The article of claim 1, wherein the temperature of the trigger object is modulatable.

6. The article of claim 1, wherein the consistency of the trigger object is modulatable.

7. The article of claim 1, wherein the size and shape of the trigger object is configured to deliver myofascial release to the user.

8. The article of claim 1, wherein the article comprises a shirt, an arm sleeve, an elbow sleeve, a sleeve, a long sleeve shirt, shorts, lower leg sleeves, full length pants, back wraps, neck wraps, braces, socks, gloves or combinations thereof.

9. The article of claim 1, wherein the article comprises housing on the inner surface of the article, wherein the housing retains the trigger object between the compression section and the trigger point in the individual.

10. The article of claim 1, wherein the article further comprises a mechanical, electrical and/or a programmable stimulation device.

11. A wearable article comprising:
one or more compression sections;
one or more trigger objects secured within one or more housings;
wherein the one or more housings are secured inside the wearable article at the one or more compression sections,
wherein the one or more compression sections are spaced apart on the wearable article;
wherein the one or more trigger objects are spherical and comprise a foam material; and
wherein the one or more housings have dimensions greater than the one or more trigger objects allowing for manual positioning of the trigger objects within the housing when the wearable object is worn by an individual.

12. The wearable article of claim 11 wherein the wearable article is a shirt, an arm sleeve, an elbow sleeve, a sleeve, a long sleeve shirt, shorts, lower leg sleeves, full length pants, back wraps, neck wraps, braces, socks, or gloves.

13. The wearable article of claim 12 wherein the wearable article is constructed from a compressive material or a fabric comprising an elastic component.

14. The wearable article of claim 12 wherein at least one of the one or more compression sections is provided to surround the individual when worn and wherein the at least one of the one or more compression sections comprise a plurality of housings with a trigger object therein wherein the plurality of housings are provided spaced apart across a surface area of the at least one of the one or more compression sections such that the trigger objects are positioned on two or more spaced apart locations of the at least one compression section.

15. The wearable article of claim 14 where the two or more locations are provided on a front, a rear, a right side, a left side or combinations thereof of the at least one of the one or more compression sections.

16. A method of delivering muscle therapy to an individual comprising:
wearing a wearable article comprising a compression section and a trigger object, wherein the compression section and the trigger object are configured to rest at a trigger point when worn by an individual, wherein the trigger object is housed in the compression section of the article; and
manipulating the trigger object to release myofascial tissue at a trigger point in the individual.

17. The method of claim 16, wherein the wearable article comprises a shirt, an arm sleeve, an elbow sleeve, a sleeve, a long sleeve shirt, shorts, lower leg sleeves, full length pants, back wraps, neck wraps, braces, socks or combinations thereof.

18. The method of claim 16, wherein the manipulating comprises modulating the pressure applied at the trigger point by the trigger object.

19. The method of claim 16, wherein the manipulating comprises adjusting the size of the trigger object for adaptability to the size of the trigger point in the myofascial release area.

20. The method of claim 16, wherein the manipulating comprises varying the temperature of the trigger object applied to the trigger point.

21. The method of claim 16, wherein the trigger object material comprises foam, metal, gel, plastic, wood, polymer, stone, rubber, cork, natural materials, corn, rice, hemp, CBD or combinations thereof.

22. The method of claim 16, wherein the article is worn for a length of time between about 10 minutes and about 60 minutes.

22. The method of claim 161, wherein the manipulating comprises moving the trigger object over the body part to release the myofascial tissue.

23. The method of claim 16, wherein the manipulating comprises moving the body part to release the myofascial tissue.

24. The method of claim 16, wherein the article is worn for muscle recovery after an athletic event, for muscle preparation before an athletic event, for improving the effectiveness of athletic training, for post-surgical recovery, for rehabilitation and/or for pain relief.
